(19) United States
(12) Patent Application Publication
(10) Pub. No.: US 2025/0167233 A1
(43) Pub. Date: May 22, 2025

(54) ANODE MIXTURE AND LITHIUM SECONDARY BATTERY

(71) Applicant: TOYOTA JIDOSHA KABUSHIKI KAISHA, Toyota-shi (JP)

(72) Inventor: Shinsuke MATSUHARA, Miyoshi-shi (JP)

(73) Assignee: TOYOTA JIDOSHA KABUSHIKI KAISHA, Toyota-shi (JP)

(21) Appl. No.: 18/761,737

(22) Filed: Jul. 2, 2024

(30) Foreign Application Priority Data
Nov. 17, 2023 (JP) 2023-195968

(51) Int. Cl. H01M 4/583; H01M 4/02; H01M 4/36; H01M 4/38; H01M 10/0525

(52) U.S. Cl. CPC H01M 4/583; H01M 4/364; H01M 4/386; H01M 10/0525; H01M 2004/027

(57) ABSTRACT

An anode mixture contains a plurality of carbon particles and a plurality of Si-based particles. The plurality of carbon particles includes a plurality of scaly graphite particles doped with boron. The content of the plurality of Si-based particles relative to the plurality of carbon particles is 5 mass % to 60 mass %. The content of the plurality of scaly graphite particles relative to the plurality of carbon particles is 1.5 mass % or more.

### CROSS-REFERENCE TO RELATED APPLICATION

This application claims priority to Japanese Patent Application No. 2023-195968 filed on Nov. 17, 2023, incorporated herein by reference in its entirety.

### BACKGROUND

### 1. Technical Field

The present disclosure relates to anode mixtures and lithium secondary batteries.

### 2. Description of Related Art

Lithium secondary batteries are used for information communication technology (e.g., personal computers and smartphones), vehicle installation, energy storage, etc.

Japanese Unexamined Patent Application Publication No. 2004-103391 (JP 2004-103391 A) discloses a non-aqueous electrolyte lithium secondary battery. This non-aqueous electrolyte lithium secondary battery includes an anode, a specific cathode, and a non-aqueous electrolyte solution. The anode includes a carbon material that can be doped and undoped with lithium. The carbon material is composed of a specific graphite not containing boron and a specific boron-containing graphite.

### SUMMARY

However, the non-aqueous electrolyte lithium secondary battery disclosed in JP 2004-103391 A has room for improvement in capacity retention rate.

The present disclosure was made in view of the above circumstances. An issue to be solved by an embodiment of the present disclosure is to provide an anode mixture that can improve the capacity retention rate of a lithium secondary battery, and a lithium secondary battery with a high capacity retention rate.

Means for solving the above issue includes the following aspects.
(1) An anode mixture containing
a plurality of carbon particles (A) and a plurality of silicon (Si)-based particles (B).
The carbon particles (A) include a plurality of boron-doped scaly graphite particles (A1).
A content (B/A) of the Si-based particles (B) relative to the carbon particles (A) is from 5 mass % to 60 mass %.
A content (A1/A) of the scaly graphite particles (A1) relative to the carbon particles (A) is 1.5 mass % or more.
(2) In the anode mixture according to (1), the content (A1/A) may be 8.0 mass % or more.
(3) In the anode mixture according to (1) or (2), the content (A1/A) may be 15.0 mass % or less.
(4) In the anode mixture according to any one of (1) to (3),
the carbon particles (A) may further include a plurality of spherical graphite particles (A2), and
a boron doping content in the scaly graphite particles (A1) may be 0.2 atm % or more.
(5) A lithium secondary battery including an anode including the anode mixture according to any one of (1) to (4).

The present disclosure provides an anode mixture that can improve the capacity retention rate of a lithium secondary battery, and a lithium secondary battery with a high capacity retention rate.

### DETAILED DESCRIPTION OF EMBODIMENTS

In the present disclosure, a numerical range indicated by using “from” means a range including the numerical values described before and after “from” as the minimum value and the maximum value, respectively. In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples. In the present disclosure, a combination of two or more preferred embodiments is a more preferred embodiment. In the present disclosure, the amount of each component means the total amount of a plurality of substances unless otherwise specified, when a plurality of substances corresponding to each component are present. In the present disclosure, the term “step” is included in the term as long as the intended purpose of the step is achieved, even if it is not clearly distinguishable from other steps as well as independent steps.

### (1) Anode Mixture

The anode mixture contains a plurality of carbon particles (A) and a plurality of Si-based particles (B). The plurality of carbon particles (A) includes a plurality of scaly graphite particles (A1) doped with boron. The content (B/A) of the plurality of Si-based particles (B) relative to the plurality of carbon particles (A) (hereinafter, also simply referred to as “content (B/A)”) is from 5 mass % to 60 mass %. The content (A1/A) of the plurality of scaly graphite particles (A1) relative to the plurality of carbon particles (A) (hereinafter, also simply referred to as “content (A1/A)”) is 1.5 mass % or more.

In the present disclosure, the “anode mixture” indicates the solid content of the anode mixture layer included in the anode of the lithium secondary battery. The lithium secondary battery may be a battery including a solid electrolyte or a battery including a non-aqueous electrolyte solution.

“Carbon particles” refers to particles including carbon. “Graphite particles” refer to particles including graphite. “Scale” means a shape with an aspect ratio of 2.1 or more. “Aspect ratio” refers to the ratio of the major diameter of a particle to the minor diameter of the particle. “Si-based particles” refer to particles containing silicon (Si).

Since the anode mixture of the present disclosure has the above-described configuration, the capacity retention rate of the lithium secondary battery can be improved. This effect is presumed to be due to, but not limited to, the following reasons. When the scaly graphite particles are doped with boron, the electronic conductivity is improved. Therefore, the conductive path for Si-based particles is easily formed. As a result, it is presumed that the anode mixture of the present disclosure can improve the capacity retention rate of the lithium secondary battery.

### (1.1) Carbon Particles (A)

The anode mixture of the present disclosure contains a plurality of carbon particles (A). The plurality of carbon particles (A) function as an anode active material. Examples of the material constituting the carbon particles (A) include graphite, hard carbon, and soft carbon. Of the above, graphite is preferable. The graphite may be natural graphite or artificial graphite. The carbon particles (A) may be coated with an amorphous carbon material.

### (1.1.1) Scaly Graphite Particles (A1)

The plurality of carbon particles (A) includes a plurality of scaly graphite particles (A1) doped with boron. The graphite constituting the scaly graphite particles (A1) may be natural graphite or artificial graphite.

The boron doping content in the scaly graphite particles (A1) is not particularly limited, and may be 0.2 atm % or more, may be 1.0 atm % or more, or may be 2.0 atm % or more. The boron doping content in the scaly graphite particles (A1) may be 3.6 atm % or less, or 3.5 atm % or less.

The aspect-ratio of the scaly graphite particles (A1) may be 2.1 or more, 3.0 or more, or 3.4 or more. The aspect-ratio of the scaly graphite particles (A1) may be 10.0 or less, 4.0 or less, or 3.8 or less.

The mean particle diameter of the plurality of scaly graphite particles (A1) is not particularly limited, and may be 2 μm to 40 μm, or 4 μm to 26 μm. The “average particle diameter” indicates a particle diameter (median diameter) corresponding to a cumulative frequency of 50% by volume from a fine particle side having a small particle diameter in a volume-based particle size distribution based on laser diffraction and light scattering.

The content (A1/A) is 1.5 mass % or more, preferably 8.0 mass % or more. The anode mixture with the content (A1/A) of 8.0 mass % or more can further improve the capacity retention rate of the lithium secondary battery. The content (A1/A) may be 10.0 mass % or more.

The content (A1/A) may be 40.0 mass % or less, may be 25.0 mass % or less, and is preferably 15.0 mass % or less. The anode mixture with the content (A1/A) of 15.0 mass % or less can efficiently improve the capacity retention rate of the lithium secondary battery even when the content of the plurality of scaly graphite particles (A1) is relatively small.

### (1.1.2) Spherical Graphite Particles (A2)

The plurality of carbon particles (A) may further include spherical graphite particles (A2). “Spherical” means a shape with an aspect ratio of less than 2.1. The graphite constituting the spherical graphite particles (A2) may be natural graphite or artificial graphite.

The spherical graphite particles (A2) may be doped with boron or may not be doped with boron. When the spherical graphite particles (A2) are doped with boron, the boron doping content in the spherical graphite particles (A2) may be the same as that exemplified as the boron doping content in the scaly graphite particles (A1).

The spherical graphite particles (A2) may have an aspect ratio of less than 2.1, 1.9 or less, or 1.7 or more. The spherical graphite particles (A2) may have an aspect ratio of 1.0 or more.

The mean particle diameter of the plurality of spherical graphite particles (A2) is not particularly limited, and may be 2 μm to 30 μm, or 4 μm to 26 μm. The method for measuring the average particle diameter is the same as the method for measuring the average particle diameter of scaly graphite particles (A1).

The content (A2/A) of the plurality of spherical graphite particles (A2) relative to the plurality of carbon particles (A) may be 60.0 mass % or more, 75.0 mass % or more, or 85.0 mass % or more. The content (A2/A) may be 98.5 mass % or less, 92.0 mass % or less, or 90.0 mass % or less.

### (1.1.3) Preferred Embodiment

It is preferable that the plurality of carbon particles (A) further include a plurality of spherical graphite particles (A2), and that the boron doping content in the scaly graphite particles (A1) be 0.2 atm % or more. Thus, the anode mixture can further improve the capacity retention rate of the lithium secondary battery.

### (1.2) Si-Based Particles (B)

The anode mixture contains a plurality of Si-based particles (B). The plurality of Si-based particles (B) function as an anode active material. Examples of the material constituting Si-based particles (B) include Si alone (silicon), Si alloy, silicon monoxide (SiO), and silicon dioxide (SiO₂). Si alloy preferably contains Si as a main component.

The aspect ratio of Si-based particles (B) is not particularly limited, and may be less than 2.1, 1.9 or less, or 1.7 or more. The aspect ratio of Si-based particles (B) may be 1.0 or more.

The mean particle size of the plurality of Si-based particles (B) is not particularly limited, and may be from 0.01 μm to 10.0 μm, or may be from 0.5 μm to 8.0 μm. The method for measuring the average particle diameter is the same as the method for measuring the average particle diameter of scaly graphite particles (A1).

The content (B/A) is from 5 mass % to 60 mass %. The content (B/A) may be 10 mass % or more or 15 mass % or more. The content (B/A) may be 40 mass % or less, 30 mass % or less, or 25 mass % or less.

### (1.3) Binder

The anode mixture may further contain a binder. Examples of the binder include polyvinylidene fluoride (PVDF), carboxymethylcellulose, rubber-based binders (e.g., butadiene rubber, hydrogenated butadiene rubber, etc.), fluoride-based binders (e.g., polyvinylidene fluoride-polyhexafluoropropylene copolymer (PVDF-HFP), polytetrafluoroethylene (PTFE), etc.), and polyolefin-based thermoplastic resins (e.g., polyethylene, polypropylene, polystyrene, etc.). The content of the binder may be 0.1 mass % to 10 mass % with respect to the total amount of the anode mixture.

### (1.4) Conductive Aid

The anode mixture may further contain a conductive aid. Examples of the conductive aid include carbon nanotubes (CNT), carbon blacks (e.g., acetylene black, furnace black, Ketjen black, etc.). The content of the conductive aid may be 0.1 mass % to 10 mass % with respect to the total amount of the anode mixture.

### (2) Lithium Secondary Battery

The lithium secondary battery of the present disclosure includes an anode. The anode includes the anode mixture of the present disclosure. Accordingly, the capacity retention rate of the lithium secondary battery of the present disclosure is excellent.

The lithium secondary battery of the present disclosure generally further includes a cathode and an ion conductive medium in addition to the anode. The ion conducting medium is interposed between the cathode and the anode and conducts carrier ions. Examples of the ion conductive medium include a non-aqueous electrolyte solution, a non-aqueous gel electrolyte solution, a solid ion conductive polymer, and an inorganic solid electrolyte.

Hereinafter, a lithium secondary battery (hereinafter, also referred to as a “non-aqueous battery”) using a non-aqueous electrolyte solution will be described.

### (2.1) Non-Aqueous Battery

The non-aqueous battery includes an anode of the present disclosure, a cathode, a separator disposed between the cathode and the anode, and a non-aqueous electrolyte solution.

### (2.1.1) Anode

The anode may have an anode mixture layer and may further have a cathode current collector (for example, copper foil or the like). The anode mixture layer is laminated on at least one main surface of the anode current collector. The anode mixture layer includes the anode mixture of the present disclosure.

### (2.1.2) Cathode

The cathode may include a cathode mixture layer, and may further include a cathode current collector (e.g., aluminum foil). The cathode mixture layer is laminated on at least one main surface of the cathode current collector.

The cathode mixture layer includes a cathode active material. The cathode active material releases lithium ions into a non-aqueous electrolyte solution or occludes from an electrolyte solution. The cathode active material may be any known cathode active material (e.g., LiNiO₂, LiNi_{1/3}Co_{1/3}Mn_{1/3}O₂). The cathode mixture layer may further contain a known conductive material (e.g., carbon black, etc.), trilithium phosphate, and a binder (e.g., polyvinylidene fluoride, etc.).

### (2.1.3) Separator

The separator maintains a gap between the cathode and the anode to prevent the occurrence of a contact short circuit, and allows lithium ions to pass through the separator. Examples of the separator include a porous resin sheet and a nonwoven fabric. Examples of the material of the porous resin sheet include polyolefins (polypropylene, polyethylene, etc.). Examples of the material of the nonwoven fabric include polypropylene, polyethylene terephthalate, and methylcellulose. The separator may have a known configuration.

### (2.1.4) Non-Aqueous Electrolyte Solution

The non-aqueous electrolyte solution may include a non-aqueous solvent and a lithium salt. Examples of the lithium salt include LiClO₄, LiAsF₆, LiPF₆, LiBF₄, LiCF₃SO₃, LiN(FSO₂)₂, and LiN(CF₃SO₂)₂. Examples of the non-aqueous solvent include cyclic carbonates (e.g., ethylene carbonate, etc.), linear carbonates (e.g., dimethyl carbonate, ethyl methyl carbonate, etc.), cyclic esters (e.g., γ-butyrolactone, γ-valerolactone, etc.), linear esters (e.g., methyl formate, methyl acetate, etc.), and ethers (e.g., dimethoxyethane, ethoxymethoxyethane, etc.). The non-aqueous electrolyte solution may contain an additive (for example, vinylene carbonate, lithium bis(oxalato) borate, or the like).

### (2.1.5) Case

Non-aqueous batteries usually have a case. The case contains a cathode, an anode, a separator, and a non-aqueous electrolyte solution. The case is not particularly limited, and examples thereof include a laminate film (for example, an aluminum sheet, etc.), and a battery can (for example, a cylindrical shape, a square shape, a coin shape, etc.).

Hereinafter, the present disclosure will be described in more detail with reference to Examples, but the disclosure of the present disclosure is not limited to these Examples.

### [1] Examples and Comparative Examples

### [1.1] Raw Materials

The following materials were prepared as a raw material of the anode mixture.

### [1.1.1] Scaly Graphite Particles (A1)

### [1.1.1.1] Scaly Graphite Particles (A1-1)

Scaly graphite particles (A1-1) were prepared as boron-doped scaly graphite particles (A1) (anode active material). Specifically, boron carbide (B₄C) as a boron precursor and a plurality of scaly graphite particles (material of particles: graphite, aspect ratio of particles: 3.5) were mixed to obtain a mixture. The blending ratio of boron carbide (B₄C) was 3.0 mass % with respect to the plurality of scaly graphite particles. The mixture was calcined at 2800° C. in an argon atmosphere for two hours. As a result, a plurality of scaly graphite particles (A1-1) were obtained.

The boron doping content in the scaly graphite particles (A1-1) was measured using XPS (X-ray photoelectron spectroscopy). Specifically, the boron doping content was calculated from the peaks (B-C bonding and assignment) in 188 eV. The measurement result of the boron doping content in the plurality of scaly graphite particles (A1-1) was 1.4 atm %.

### [1.1.1.2] Scaly Graphite Particles (A1-2)

Scaly graphite particles (A1-2) were prepared as boron-doped scaly graphite particles (A1) (anode active material). Specifically, a plurality of scaly graphite particles (A1-2) were obtained in the same manner as in the preparation of scaly graphite particles (A1-1) except that the blending ratio of boron carbide (B₄C) with respect to the plurality of scaly graphite particles was changed to 0.5 mass %. The measurement result of the boron doping content in the scaly graphite particles (A1-2) was 0.2 atm %.

### [1.1.1.3] Scaly Graphite Particles (A1-3)

A plurality of scaly graphite particles (A1-3) were prepared as boron-doped scaly graphite particles (A1) (anode active material). Specifically, a plurality of scaly graphite particles (A1-2) were obtained in the same manner as in the preparation of scaly graphite particles (A1-1) except that the blending ratio of boron carbide (B₄C) was changed to 10.0 mass % with respect to the plurality of scaly graphite particles. The measurement result of the boron doping content in the scaly graphite particles (A1-3) was 3.5 atm %.

### [1.1.2] Scaly Graphite Particles (X)

As non-boron-doped scaly graphite particles (X), a plurality of scaly graphite particles (X-1) (material of particles: graphite, aspect ratio of particles: 3.3) were prepared.

### [1.1.3] Spherical Graphite Particles (A2)

As non-boron-doped spherical graphite particles (A2) (anode active material), a plurality of spherical graphite particles (A2-1) (material of particles: artificial graphite) were prepared.

### [1.1.4] Si-Based Particles (B)

As Si-based particles (B) (anode active material), a plurality of silicon particles (B-1) (material of particles: silicon) were prepared.

### [1.2] Comparative Example 1

A plurality of scaly graphite particles (X-1) and a plurality of spherical graphite particles (A2-1) were mixed to obtain a plurality of carbon particles (A). The ratio (X/A) of the plurality of scaly graphite particles (X-1) to the sum of the plurality of scaly graphite particles (X-1) and the plurality of spherical graphite particles (A2-1) (i.e., the plurality of carbon particles (A)) was 10.0 mass %. A plurality of carbon particles (A) and a plurality of Si-based particles (B-1) were mixed to obtain an anode mixture. The content (B/A) of the plurality of Si-based particles (B-1) relative to the plurality of carbon particles (A) was 20 mass %.

### [1.3] Examples 1 to 8 and Comparative Examples 2 to 4

A plurality of scaly graphite particles (A1) and a plurality of spherical graphite particles (A2-1) shown in Table 1 were mixed to obtain a plurality of carbon particles (A). The ratio of the plurality of scaly graphite particles (A1) to the sum of the plurality of scaly graphite particles (A1) and the plurality of spherical graphite particles (A2-1) (i.e., the plurality of carbon particles (A)) (A1/A) was the ratio shown in Table 1. A plurality of carbon particles (A) and a plurality of Si-based particles (B-1) were mixed to obtain an anode mixture. The content (B/A) of the plurality of Si-based particles (B-1) relative to the plurality of carbon particles (A) was 20 mass %.

### [2] Evaluation of Capacity Retention Rate

### [2.1] Production of Lithium Secondary Battery

A lithium secondary battery was prepared as follows.

### [2.1.1] Cathode

A LiNiCoMnO₂ was prepared as the cathode active material. As a conductive aid, acetylene black (AB) was prepared. Polyvinylidene fluoride (PVdF) was prepared as a binder.

A cathode mixture paste was prepared by mixing a cathode active material, a conductive aid, a binder, and a solvent. The mass ratio of the cathode mixture paste (cathode active material: conductive aid: binder) was 92:5:3. The cathode mixture paste was applied to an aluminum foil (thickness: 15 μm), dried, and pressed. As a result, a cathode was obtained. The thickness of the cathode active material layer of the cathode was a predetermined thickness.

### [2.1.2] Anode

Carboxymethylcellulose (CMC) was prepared as Binder A. As binder B, styrene-butadiene rubber (SBR) was prepared.

The obtained anode mixture, the conductive aid, the binder A, the binder B, and the solvent were mixed to prepare an anode mixture paste. The mass ratio of the anode mixture paste (anode active material: conductive aid: binder A: binder B) was 97:1:1:1. Incidentally, the insoluble CMC was calculated as the active material weight. The anode mixture paste was applied to a copper foil (thickness: 10 μm), dried, and pressed. As a result, an anode was obtained. The thickness of the cathode active material layer of the anode was a predetermined thickness.

### [2.1.3] Separator

As a separator, a porous sheet having a three-layer structure (thickness: 24 μm) was prepared. The porous sheet is formed by laminating a polypropylene (PP) layer, a polyethylene (PE) layer, and a PP layer in this order. A layer (4 μm) of ceramic (alumina, boehmite, etc.) was applied to one side of the separator.

### [2.1.4] Non-Aqueous Electrolyte Solution

As a non-aqueous electrolyte solution, a mixture of a mixed solvent and LiPF₆ as a support salt was prepared. The mixed solvents consist of ethylene carbonate (EC), dimethyl carbonate (DMC) and ethyl methyl carbonate (EMC). The volume ratio (EC:DMC:EMC) of the mixed solvents was 3:3:4. The density of LiPF₆ was 1 mol/L.

### [2.1.5] Assembly

The cathode and the anode were wound with a separator interposed therebetween to form an electrode group. The ceramic layer of the separator was opposite the cathode. A current collector plate with a lid was welded to both ends of the electrode group, the electrode group was inserted into the case, and the lid plate and the case were welded. A predetermined amount of non-aqueous electrolyte solution was injected from the injection hole of the case, and a sealing screw was tightened to the injection hole. After injection of the non-aqueous electrolyte solution, the electrode group was impregnated with the non-aqueous electrolyte solution at an appropriate time, the electrode group was charged, and aged at 60° C. As a result, a lithium secondary battery was obtained.

### [2.2] Evaluation of life (Cycle) Characteristics

The lithium-ion secondary batteries were charged and discharged so that the rate-loading became 2 C in a 60° C. atmosphere. SOC ranged from 0% to 100%, was performed for 300 cycles, and the battery capacity at the time of the first discharge (hereinafter, also referred to as “first capacity”) and the battery capacity after 300 cycles (hereinafter, also referred to as “300 cycle capacity”) were measured. The capacity retention rate was calculated from the following Equation (A). The results are shown in Table 1. The higher the capacity retention rate, the better the battery characteristics can be evaluated. An acceptable range of capacity retention rate is 77% or more.

Capacity retention rate (%)=(300 cycles after cycle/initial capacity)×100. Equation (A):

### [3] Results

]TABLE 1

| | Carbon particles (A) | | | | | | | | | | |
|---|---|---|---|---|---|---|---|---|---|---|---|
| | Scaly graphite | | | Scaly graphi [symbol] | | | Spherical graphi [symbol] | | Si-based | | Evaluation |
| | particles (A1) | | | particles (X) | | | particles (A2) | | Particles (B) | | Capacity |
| | | [symbol] | [symbol] | | [symbol] | [symbol] | | Content | | Content | Retention |
| | Particle | Content | (A1/A) | Particle | Content | (X/A) | Particle | (A2/A) | particle | (B/A) | Rate |
| | type | atom % | mass % | type | atom % | mass % | type | mass % | type | mass % | % |
| Comparative Example 1 | — | — | — | [symbol] | 0 | 10.0 | A2-1 | 90.0 | B-1 | 20 | [symbol] |
| Example 1 | A1.1 | 1.4 | 10.0 | — | — | 0 | A2-1 | 90.0 | B-1 | 20 | [symbol] |
| Example 2 | A1.2 | 0.2 | 10.0 | — | — | 0 | A2-1 | 90.0 | B-1 | 20 | [symbol] |
| Example 3 | A1.3 | [symbol] .5 | 10.0 | — | — | 0 | A2-1 | 90.0 | B-1 | 20 | [symbol] |
| Comparative Example 2 | A1. [symbol] | [symbol] .5 | 0.5 | — | — | 0 | A2-1 | 99.5 | B-1 | 20 | [symbol] |
| Example 4 | A1.3 | 3.5 | 1.5 | — | — | 0 | A2-1 | 98.5 | B-1 | 20 | [symbol] |
| Example 5 | A1.3 | 3.5 | 20.0 | — | — | 0 | A2-1 | 80.0 | B-1 | 20 | [symbol] |
| Comparative Example 3 | A1.1 | 1.4 | 10.0 | — | — | 0 | A2-1 | 90.0 | B-1 | 1 | [symbol] |
| Example 6 | A1.1 | 1.4 | 10.0 | — | — | 0 | A2-1 | 90.0 | B-1 | 5 | [symbol] |
| Example 7 | A1.1 | 1.4 | 10.0 | — | — | 0 | A2-1 | 90.0 | B-1 | 40 | [symbol] |
| Example 8 | A1.1 | 1.4 | 10.0 | — | — | 0 | A2-1 | 90.0 | B-1 | 60 | [symbol] |
| Comparative Example 4 | A1.1 | 1.4 | 10.0 | — | — | 0 | A2-1 | 90.0 | B-1 | 80 | [symbol] |

[symbol]

indicates data missing or illegible when filed

The anode mixture of Comparative Example 1 did not contain a plurality of scaly graphite particles (A1). Therefore, the capacity retention rate of Comparative Example 1 was not 77% or more.

In the anode mixture of Comparative Example 2, the content (A1/A) was not 1.5 mass % or more. Therefore, the capacity retention rate of Comparative Example 2 was not 77% or more. In Comparative Example 3 and Comparative Example 4, the content (B/A) was not 5 mass % to 60 mass %. Therefore, the capacity retention rates of Comparative Example 3 and Comparative Example 4 were not 77% or more.
From these results, it was found from Comparative Example 1 that the anode mixture of Comparative Example 4 was not a “anode mixture capable of improving the capacity retention rate of the lithium secondary battery”.

The anode mixture of Examples 1 to 8 contained a plurality of carbon particles (A) and a plurality of Si-based particles (B). The plurality of carbon particles (A) contained scaly graphite particles (A1). The content (B/A) was from 5 mass % to 60 mass %.

The content (A1/A) was 1.5 mass % or more. Therefore, the capacity retention rates of Examples 1 to 5 were 77% or more.
From these results, it was found that the anode mixture of Examples 1 to 8 was a “anode mixture capable of improving the capacity retention rate of the lithium secondary battery”.

What is claimed is:

1. An anode mixture containing a plurality of carbon particles (A) and a plurality of silicon-based particles (B), wherein
the carbon particles (A) include a plurality of boron-doped scaly graphite particles (A1),
a content (B/A) of the silicon-based particles (B) relative to the carbon particles (A) is from 5 mass % to 60 mass %, and
a content (A1/A) of the scaly graphite particles (A1) relative to the carbon particles (A) is 1.5 mass % or more.

2. The anode mixture according to claim 1, wherein the content (A1/A) is 8.0 mass % or more.

3. The anode mixture according to claim 2, wherein the content (A1/A) is 15.0 mass % or less.

4. The anode mixture according to claim 1, wherein:
the carbon particles (A) further include a plurality of spherical graphite particles (A2); and
a boron doping content in the scaly graphite particles (A1) is 0.2 atm % or more.

5. A lithium secondary battery comprising an anode including the anode mixture according to claim 1.
